(19) United States
(12) Patent Application Publication
(10) Pub. No.: US 2004/0219472 A1
(43) Pub. Date: Nov. 4, 2004

(54) Mini uni-twin orthodontic bracket

(75) Inventors: Thomas D. Creekmore, Houston, TX (US); Leslie Creekmore, Houston, TX (US)

Correspondence Address: JAMES L. JACKSON, ANDREWS & KURTH, L.L.P., SUITE 4200, 600 TRAVIS, HOUSTON, TX, 77002, US

(73) Assignee: GARY T. CREEKMORE, INC. D/B/A CREEKMORE ENTERPRISES

(21) Appl. No.: 10/428,402

(22) Filed: May 1, 2003

(51) Int. Cl. A61C 3/00

(52) U.S. Cl. 433/8

(57) ABSTRACT

A uni-twin orthodontic bracket defining a facial surface has a bracket base defining a central bracket section and mesial and distal tie-wing sections and defines a active precision edgewise slot having mesial and distal ends and having parallel slot side surfaces and a slot bottom surface and adapted to receive an edgewise archwire in force transmitting relation therein. A mounting surface is defined by the bracket base and is oriented at a desired torque angle with respect to the facial surface and the parallel slot side surfaces. The mounting surface is adapted to be fixed in relation to the facial surface of a patient's tooth and positions the parallel slot side surfaces at a desired torque angle. The mesial and distal bracket sections define mesial and distal tie-wings and define archwire relief areas establishing clearance with an edgewise archwire.

### RELATED INVENTION

The present invention is related to the subject matter of U.S. Pat. No. 4,531,911 of Thomas D. Creekmore, issued on Jul. 30, 1985, which patent is incorporated by reference herein for all purposes.

### BACKGROUND OF THE INVENTION

1. Field of the Invention

The present invention relates generally to orthodontic brackets for use in edgewise orthodontic procedures and incorporating the attributes of both single and twin type orthodontic brackets. More particularly, the present invention is directed to edgewise orthodontic brackets having an edgewise archwire slot being centrally located and oriented 0° torque and with the desired degree of torque being established by an angulated mounting base surface for bonding to a desired labial or lingual surface of a tooth. Even more particularly, the present invention concerns a uni-twin edgewise orthodontic bracket having a central precision edgewise archwire slot and having narrow archwire relief areas mesial and distal of the ends of the precision archwire slot and with the relief areas having the same or less depth as compared with the depth of the archwire slot.

2. Description of the Prior Art

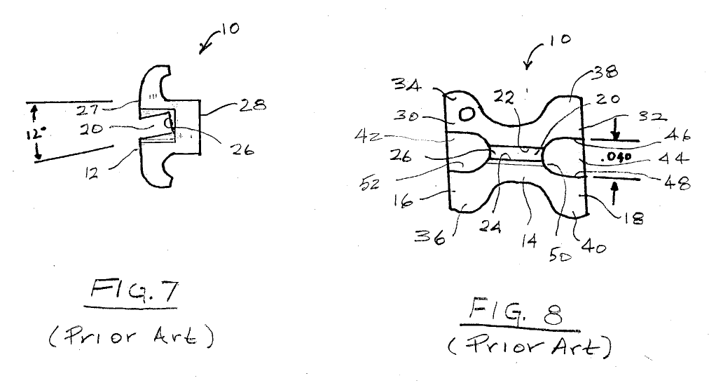

Following the grant of U.S. Pat. No. 4,531,911, uni-twin edgewise orthodontic brackets have generally taken the form shown in FIG. 21 of the patent. The mounting base of the bracket is typically oriented in generally parallel relation with the upper surface and twin tiewings of the bracket structure, and the precision edgewise orthodontic slot is angularly oriented relative to the facial surface of the bracket base to establish the desired torque capability of the bracket during orthodontic treatment of a patient. An edgewise archwire, having a rectangular cross-sectional configuration, with parallel archwire surfaces closely matching respective archwire slot surfaces, as is evident from FIGS. 18 and 20 of the patent, is twisted by an orthodontist to an angle permitting its entry into the angulated archwire slot, without exceeding the elastic limit of the material from which the archwire is constructed. The archwire is then ligated in place within the precision archwire slot through the use of ligature wires or elastic ligating members. The elastic ligating members are typically supplied in the form of O-rings and are stretched over the archwire and under the tiewings as is also evident from FIGS. 18 and 20, thus securing the archwire in fully seated relation within the precision archwire slot. Since the edgewise archwire is composed of spring-like metal material, the twisted archwire tends to untwist, thereby applying torque force through the orthodontic bracket to the tooth of the patient. The torque force causes a torque force to be applied between the tooth and the bone of the alveolar arch of the patient, causing selective adsorption and resorption of the bone structure and resulting in substantially permanent movement of the tooth to desired orientation and position with respect to the bone structure.

For purposes of this invention, tipping movement of the teeth is defined as rotation of the long axis of a tooth in the mesial-distal direction. Torque movement of a patient's tooth constitutes rotation of the long axis of a tooth in the buccal-lingual direction. Rotation movement of a patient's tooth is defined as movement of the tooth about its long axis in a mesio-distal direction. Tip, torque and rotation, according to edgewise orthodontic therapy, are accomplished by the fit between the archwire and the archwire slot of an edgewise orthodontic bracket and by the condition of the archwire, i.e., twisted or flexed.

The most widely utilized orthodontic therapy technique in this country, and the technique to which this invention is directed, is the “edgewise” technique, which was brought to the industry by Dr. Edward H. Angle. It should be understood, however, that this invention is also applicable to other orthodontic techniques such as the multi-phase and twin wire edgewise techniques, for example. In the beginning stages of edgewise therapy, archwires of circular cross-sectional configuration are employed. The greater flexibility of the round archwire permits greater range of movement of malposed teeth with less force to the teeth. For secondary and finishing therapy, the edgewise technique typically incorporates a multibanded precision appliance consisting of a labial archwire of rectangular cross-section that is ordinarily of greater dimension at the sides than at the edges thereof. The archwire is fitted and ligated with metal ligature wire, or ligature elastics, or any other suitable form of mechanical retention, into precision mating horizontal archwire slots that are formed in brackets on all of the permanent teeth including first molars and frequently second molars. The two ends of the archwire terminate in buccal tubes each having a passage of rectangular cross-section through which the ends of the rectangular archwire extend. The archwire, which maybe composed of stainless steel or precious alloy, is typically positioned with its narrow dimension or edge lying against the labial and buccal surfaces of the teeth. This feature gives the technique its name “edgewise”.

The edgewise technique makes control possible in all directions and any individual tooth may be moved simultaneously in three directions; for example, an incisor may be moved lingually, distally and rotated around its long axis with one adjustment of the archwire.

The rectangular cross-sectional configuration of the archwire permits it to be twisted to a desired extent and, being of spring-like nature, the twisting forces will be applied through the archwire to the orthodontic bracket and thence to the teeth, thereby inducing a torquing movement of the teeth as the archwire untwists due to spring action and returns to its normal untwisted configuration. The archwire slots of edgewise orthodontic brackets are precision milled or formed to a rectangular configuration so that the orthodontist can select a precision milled archwire to fit within the archwire slots of the brackets as precisely as desired. Tip, torque and rotation are accomplished by the fit between the archwire and bracket. Extra oral anchorage may or may not be used as desired. Reciprocal anchorage can be provided by extraction of teeth and by selectively utilizing teeth posterior to extraction sites to retract teeth anterior to the extraction sites with intra and inter maxillary elastics and/or closing loop archwires. This invention is specifically directed to the edgewise technique and more specifically concerns an orthodontic appliance system that integrates specific advantages that are afforded by edgewise appliances having both single and twin ligating capability.

Single tie wing brackets for the edgewise technique typically incorporate a base structure which defines a precision active archwire slot that receives a precision archwire of rectangular cross-section. A pair of ligating tie wings extend from the bracket base on opposite, i.e., gingival and occlusal sides of the precision archwire slot. These tie wings are typically centered with respect to the bracket structure and the archwire slot and are therefore intended to be positioned in substantially centered mesio-distal relationship with the facial surface of the tooth to which the bracket is secured. A ligature wire or elastic is looped over each of the tie wings and is passed over the archwire at each end of the slot, thus securing the archwire firmly in its precision slot.

Single brackets provide maximum efficiency in the application of tipping and torquing of teeth but are minimally efficient in rotational control. Initially, rotational control was accomplished by soldering or welding eyelets at the extreme mesial or distal of the band attached to the tooth. The orthodontist could ligate the eyelet to the archwire, pulling that surface closer to the archwire and causing the tooth to rotate about the centrally located bracket. This is a cumbersome and inefficient method of rotational control.

Subsequently, fixed or flexible rotation levers, projecting mesially and distally, were added to the centrally located single bracket. Thus, a rotated tooth would have the rotation wing projecting more facially than the bracket. The archwire would touch the rotation wing and, as the wire is ligated into the bracket, cause the tooth to rotate about the bracket. The rotation lever is adjustable to project more or less to the facial as desired. This permits the orthodontist to select the amount of rotation desired by adjusting the rotation lever rather than adjusting the archwire.

The disadvantage of the rotation lever approach to tooth movement is evident in the initial stages of treatment. The archwire will not touch the rotation lever if a tooth is tipped and rotated severely and will prevent either action from occurring unless the archwire is adjusted to strike the rotation lever when ligated. Thus, initial archwire insertion can be inefficient and can require more expertise to ligate.

Twin brackets were introduced to alleviate the inefficient rotation effectiveness of the single bracket. Instead of one centrally located bracket, two spaced brackets were placed at the mesial and distal portions of the tooth. Thus, when each bracket is ligated to the archwire, the facial surface of the tooth will become aligned with the archwire, thus rotating the tooth.

One of the principles of tooth rotation in orthodontics is over-correction of the original problem to compensate for the rebound or relapse tendency and to provide for more rapid movement of teeth to their desired final positions. This is especially indicated for rotated teeth. Twin brackets do not have the capacity for over-rotation. For over-rotation with twin brackets, the archwire must be bent or some auxiliary must be added to push the mesial or distal portion of the bracket away from the archwire. Further, single edgewise brackets, without rotation levers, are also lacking in over-rotation control capability which will be discussed in more detail herein below.

One of the more important advantages of single brackets is the advantage that is afforded by the active length of archwire existing between the points of connection to adjacent brackets. This is known as “interbracket width”. Since the connecting point between adjacent single brackets is established at substantially the center of the adjacent teeth, the archwire length, and thus the interbracket width, extends to points near the centers of adjacent teeth. The lengthy archwire span that exists between single brackets allows lower magnitude forces to be applied to the teeth over longer periods of time as compared to circumstances where the interbracket width is limited and the archwire span is short as is the case when conventional twin brackets are employed. The long span of archwire may be twisted much further without exceeding the elastic limit of the archwire material and causing permanent yielding or deformation of the archwire. Where the archwire between brackets is of limited length, which is typical where twin brackets are employed with the edgewise technique, application of large magnitude forces to the teeth can occur with only minimal twisting or flexing of the archwire. Thus, after limited movement of the teeth occurs, the forces induced by the short archwire interbracket width dissipate quickly, thereby requiring frequent adjustment in order to maintain optimum force application for efficient tooth movement. Of course, it is evident that frequent adjustment of orthodontic appliances necessitates frequent visits by the patient for adjustment of the orthodontic appliance and is disadvantageous to the patient. Such frequent adjustment also requires a significant amount of chair time in the office of the orthodontist, thereby either increasing the cost of treatment to the patient, or minimizing the commercial advantage of orthodontic treatment on the part of the doctor. It is desirable, therefore, to provide a system for orthodontic treatment wherein patient visits are minimized and practitioners chair time is also minimized, to the mutual benefit of both the patient and doctor.

Twin brackets for the edgewise technique have been employed for a considerable period of time. Twin brackets typically incorporate a pair of spaced projections that extend from or are formed by the bracket base, each projection being formed to define a precision active archwire slot segment. The spaced active archwire slot segments cooperate to define a precision archwire slot having the effect of extending the entire length of the base. Each of the projections is provided with upper and lower tie wings, thereby defining a bracket structure with four tie wings, the tie wings and the effective archwire slot terminating at the opposed side portions of the base structure. With the base structure centered in respect to the tooth to be moved, the tie wings will be positioned in pairs at opposed mesial and distal sides of the tooth, thereby defining bracket structure with efficient rotation control. The orthodontist may utilize ligature wire or elastic ligature members between selected tie wings and the archwire to develop the force moments that are necessary for efficient rotational control.

One of the typical disadvantages in utilizing twin brackets is the minimization of interbracket width that exists as the result of positioning the tie wings at opposed mesial and distal side portions of the bracket structure. Ordinarily, as explained above, minimization of interbracket width, in conjunction with the edgewise orthodontic technique, suffers the disadvantage of requiring frequent patient visits and increasing chair time because of the necessity for frequent adjustment of the appliance in order to maintain the force levels within the optimum range for efficient tooth movement.

Another significant disadvantage of twin brackets is that the spaces that are typically available between the tie wings of adjacent brackets leave insufficient room between the teeth for closing loops and tie-back loops. It is desirable, therefore, to provide an orthodontic bracket structure that affords the advantages offered by twin brackets and yet provides ample space between certain tie wings of adjacent brackets to facilitate efficient use of closing loops and tie-back loops in conjunction with edgewise orthodontic therapy.

Uni-twin edgewise orthodontic appliances or brackets have been used extensively since issuance of U.S. Pat. No. 4,531,911. There are, however, features of conventional uni-twin brackets that are considered disadvantageous. These brackets are typically manufactured by machining, leaving relatively sharp machined corners and edges that can cut the oral tissue of a patient under certain circumstances. Moreover, the sharp corners and edges are often burred as the result of the machining process, thus requiring further material preparation, such as tumbling, to minimize the presence of sharp corners and edges, resulting in additional costs of manufacture. It has been determined that manufacture of uni-twin orthodontic brackets using an injection molding process, with powdered metal being injection molded and sintered, results in an appliance structure having rounded or radiused corners and edges, thus eliminating the necessity for an additional tumbling process during manufacture. Ordinarily the relief areas at the ends of the archwire slot are manufactured by moving a rotating milling cutter or burr either downwardly or endwise toward the archwire slot. This machining process causes milling marks of the milling cutter, especially to accommodate an angulated archwire slot for torque, to leave the ends of the archwire slot higher in certain areas as compared with the depth of the slot ends. The result of the machining process leaves essentially contact points that are engaged by the archwire, and permits pivotal contact to be established between the archwire and the bottom surface of the archwire slot. These pivotal contacts essentially establish fulcrum points at end of the archwire slot which cause the loss of some rotational and over-rotational control capability, somewhat defeating the benefit for which the uni-twin bracket was designed. It is therefore desirable to provide for bracket design and construction that promotes efficient rotational and over-rotational control to the mutual benefit of the orthodontist and patient.

### SUMMARY OF THE INVENTION

It is a principal feature of the present invention to provide a novel uni-twin orthodontic bracket system, which allows the application of rotation and over-rotation control forces to the teeth of a patient responsive to structural interaction of the archwire with the surfaces of the precision archwire slot and which permit efficient use of ligature wires and elastics to promote rotational and over-rotational control of the teeth during edgewise orthodontic therapy.

It is also a feature of the present invention to provide a novel orthodontic bracket system employing twin tie wings for effective rotational control and also providing the archwire with maximum interbracket width, such as is ordinarily afforded by single brackets for maintenance of maximum active archwire length between adjacent brackets.

It is an even further feature of this invention to provide a novel orthodontic bracket system which employs twin tie wings for optimum rotational control and yet also employs a centrally oriented bracket section forming a precision machined active archwire slot which promotes controlled tipping and torquing movement of teeth, such as is typically accomplished through the use of single tie wing type brackets in accordance with conventional edgewise therapy.

It is another feature of the present invention which provides a novel uni-twin edgewise orthodontic bracket design which eliminates the presence of fulcrum points at the ends of the archwire slot and thus maximizes the effect of rotational control during orthodontic therapy.

It is an even further feature of the present invention to provide a novel uni-twin edgewise orthodontic bracket design which promotes manufacture of the brackets by an injecting molding and sintering process that results in the formation of rounded or radiused corners and edges and provides finished brackets that do not require tumbling or other corner and edge preparation to enable safe and efficient use of the brackets.

Among the several objects of this invention is contemplated the provision of a novel orthodontic bracket system utilizing twin tie wing capability and yet providing sufficient space between certain adjacent brackets for efficient employment of tie-back loops and closing loops.

It is also a feature of this invention to provide a novel single/twin orthodontic bracket system having greater rotational control and over-rotation capability as compared to conventional twin brackets.

It is an even further feature of this invention to provide a novel orthodontic bracket concept enabling an orthodontist to selectively utilize various combinations of rotation and over-rotation control, torque and tipping simply through selection of various uni-twin brackets that each embody a centralized or intermediate bracket section forming a precision active archwire slot in accordance with the principles of the present invention.

Another feature of this invention is to provide a novel orthodontic bracket structure which permits application of efficient force vectors from ligature member to an edgewise archwire, thus promoting over-rotation control as well as promoting application of other forces to the teeth of a patient.

It is another feature of this invention to provide a novel single/twin orthodontic bracket, which is of simple nature, is comparable with other orthodontic brackets from the standpoint of ease of installation and use and suffers no competitive disadvantage in comparison with other similar orthodontic bracket systems.

Briefly, uni-twin edgewise orthodontic brackets, according to this invention, incorporate a base or body structure which is adapted to be secured in immovable relation with a tooth. The base may be attached to bands that are positioned about the teeth and cemented in place or the base may be adapted for direct bonding to the tooth structure. In one form of the invention, the base defines mesial and distal sections each defining upper and lower tie wings for ligation. Between the mesial and distal ends of the bracket is defined an intermediate or archwire active section which may be separate from the tie wing projections, if desired, or, in the alternative, may be an integral part of a single projection defining spaced tie wing portions and an intermediate archwire active section. The intermediate section of the orthodontic bracket defines a precision active archwire slot having a rectangular cross-sectional configuration that is defined by facing parallel planar gingival and occlusal side surfaces and a substantially planar slot bottom surface according to edgewise therapy technique. The mesial and distal tie wing sections of the orthodontic bracket structure are each formed to define archwire relief grooves or areas extending mesially and distally from respective mesial and distal ends of the archwire slot and establishing clearances through which the archwire extends. The occlusal/gingival width of these clearance areas is in the order of 0.030 mm as compared to the much wider widths of the relief areas, 0.040 mm of conventional uni-twin orthodontic brackets, thus enhancing the structural integrity of the brackets so that bracket breakage resulting from stress is virtually eliminated, even when the brackets are composed of the clear or opaque polymer materials that are in use at the present time. These relief areas or grooves or areas are not cooperatively active with the archwire, but rather define archwire relief which allows archwire controlled tooth movement to be accomplished by archwire transmitted force activity solely from force transfer from an edgewise archwire to the intermediate archwire active section of the bracket. The inactive archwire grooves in the tie wing sections of the bracket structure may be defined by occlusal and gingival relief slot side surfaces that are not of arcuate configuration resulting from their formation by a rotary milling cutter or burr, but rather diverge in width from the respective ends of the precision archwire slot outwardly toward the respective mesial and distal ends of the bracket. Since the surfaces of the archwire relief grooves diverge outwardly in occlusal-gingival width, the archwire grooves provide sufficient structural relief that the tie wing portions of the bracket structure do not interfere with the archwire and thereby permit the precision active slot of the intermediate section of the bracket to provide sole archwire responsive tipping and torquing of the teeth. Further, by providing the bracket with an archwire active intermediate section and by preventing archwire interference at the twin tie wing portions of the bracket structure, there is defined maximum interbracket width of the archwire between adjacent orthodontic brackets. This feature allows maximum archwire controlling activity, as if the bracket structure were only as wide as the small intermediate section of the bracket or the width of a single edgewise orthodontic bracket. Accordingly, the significantly wide interbracket width defined by the relief between the ends of the archwire slots of the orthodontic brackets of adjacent teeth is provided primarily for the accomplishment of rotation and over-rotation.

The archwire slot of the uni-twin edgewise orthodontic bracket of the present invention is oriented in substantially perpendicular relation with the flat or gently curved facial surface of the bracket, thus having torque of substantially 0° rather than being angulated for torque as has been the case with previous uni-twin edgewise orthodontic brackets. Thus, the bracket design promotes efficient manufacture by an injection molding and sintering process and promotes enhance structural integrity of the brackets. The injection molding and sintering process results in the formation of rounded or radiused corners and edges that eliminates the need for tumbling and other finishing operations that have typically been used for the manufacture of edgewise orthodontic brackets. To also design the brackets for application of torque forces to a patient's teeth, the base structure of the brackets are provided with a mounting base surface that is oriented at a desired angle for the torque that is intended. This mounting base surface is designed for direct attachment to the tooth of the patient, such as by a bonding procedure, but can be welded or otherwise attached to bands in the event such is the orthodontist's preference.

Under circumstances where twin ligating capability is desired and closing loops and tie-back loops are also desired, the uni-twin orthodontic bracket structure of the present invention have pairs of spaced ligating tie wings on the occlusal and gingival portions thereof enabling efficient application of closing and tie-back forces through ligation. The bracket structure will be such as to define a precision active archwire slot intermediate the extremities thereof and with outer portions of the bracket structure relieved so as to receive the edgewise archwire in a noninterfering or inactive relation.

Other and further objects, advantages and features of the present invention will become apparent to one skilled in the art upon consideration of this entire disclosure. The form of the invention, which will now be described in detail, illustrates the general principles of the invention, but it is to be understood that this detailed description is not to be taken as limiting the scope of the present invention. It is possible that the invention may take many suitable forms other than that specifically discussed, without departing from the spirit and scope of this invention.

### BRIEF DESCRIPTION OF THE DRAWINGS

In order that the manner in which the above recited advantages and features of this invention are attained and can be understood in detail, more particular description of the invention, briefly summarized above, may be had by reference to the specific embodiments thereof that are illustrated in the appended drawings, which drawings form a part of this specification. It is to be understood, however, that appended drawings illustrate only typical embodiments of the invention and are, therefore, not to be considered limiting of its scope, for the invention may admit to other equally effective embodiments.

### IN THE DRAWINGS

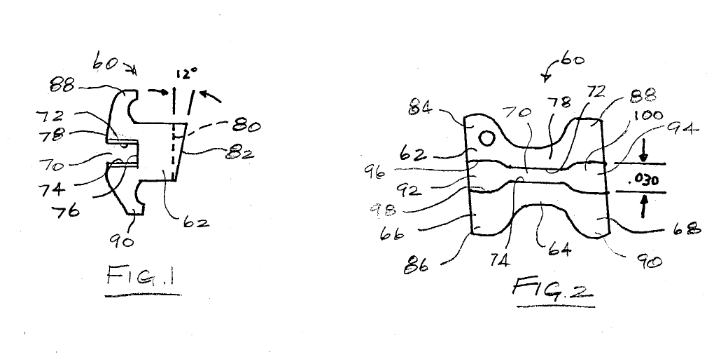

FIG. 1 is a side elevational view showing a uni-twin orthodontic bracket that is constructed according to the principles of the present invention and by broken line illustrates orientation of the bracket base with respect to the twin-type tiewings and in full line illustrates and angulated bonding surface for establishing desired torque;

FIG. 2 is a plan view showing the uni-twin orthodontic bracket of the present invention and illustrating the relationship of the precision edgewise archwire slot of the central bracket section and archwire relief areas at mesial and distal ends of the archwire slot;

FIG. 3 is a longitudinal sectional view of a uni-twin orthodontic bracket embodying the principles of the present invention and showing the bottom surfaces of the precision archwire slot and the mesial and distal relief areas as being co-planar;

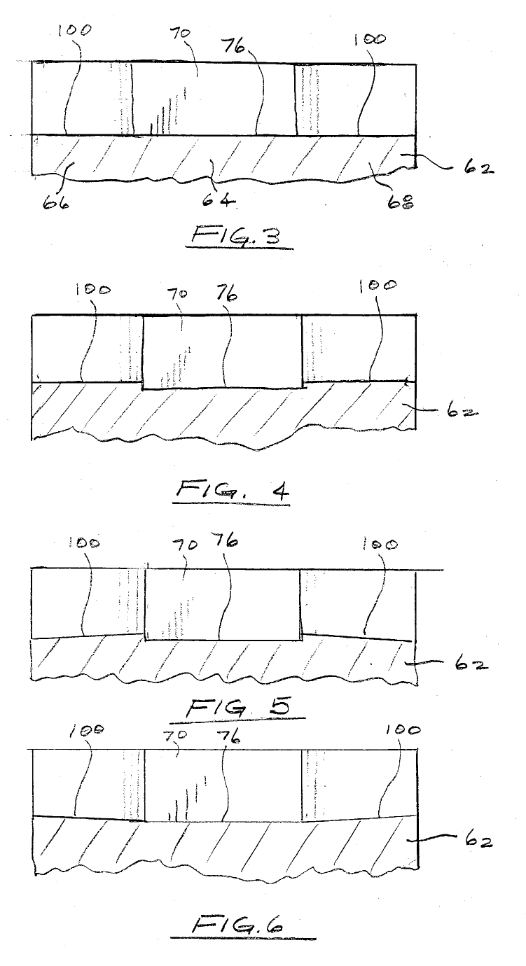

FIG. 4 is a longitudinal sectional view of a uni-twin orthodontic bracket representing an alternative embodiment of the present invention and showing the bottom surfaces of the precision archwire slot and the mesial and distal relief areas as being of different depths and with the bottom surfaces of the archwire relief areas being of less depth as compared with the depth of the archwire slot;

FIG. 5 is a longitudinal sectional view of a uni-twin orthodontic bracket representing another embodiment of the present invention and showing the bottom surfaces of the mesial and distal relief areas as being angularly oriented and having a maximum depth as great as the depth of the archwire slot and a minimum depth less than the depth of the archwire slot;

FIG. 6 is a longitudinal sectional view of a uni-twin orthodontic bracket representing a further embodiment of the present invention and showing the bottom surfaces of the mesial and distal relief areas as being oppositely angularly oriented as compared with the embodiment of FIG. 5 and having a maximum depth as great as the depth of the archwire slot and a minimum depth less than the depth of the archwire slot;

FIG. 7 is a side elevational view of a uni-twin type orthodontic bracket representing the prior art and which is designed for edgewise therapy with its precision archwire slot being angulated with respect to the bracket body and mounting base surface to establish a desired torque force; and

FIG. 8 is a plan view of the prior art uni-twin type orthodontic bracket of FIG. 3 and showing mesial and distal archwire relief areas having a width of 0.040 mm and being cut deeper than the depth of the precision archwire slot.

### DETAILED DESCRIPTION OF PREFERRED EMBODIMENT

FIGS. 7 and 8 of the drawings are representative of the prior art as indicated and illustrate a conventional uni-twin orthodontic bracket generally at 10 having a bracket base or body 12 defining an intermediate active archwire slot section 14 and mesial and distal tiewing sections 16 and 18. The intermediate active archwire slot section 14 defines a precision edgewise archwire slot 20 that is defined by spaced planar gingival and occlusal archwire slot surfaces 22 and 24 being disposed in parallel relation and a bottom archwire slot surface 26 that is also of planar configuration and is oriented in 90°, i.e., perpendicular relation with the archwire slot surfaces 22 and 24.

As is evident from the illustration of prior art FIG. 7, the precision archwire slot 20 is oriented in angular relation with a facial surface 27 and a mounting surface 28 of the base or body structure of the orthodontic bracket to thus provide the bracket with a desired amount of torque force for the orthodontic treatment that is indicated for that particular tooth of the patient. As shown, the angle of the precision archwire slot is 12° relative to the facial surface and the mounting base surface, but may be any other angle that is desired by an orthodontic practitioner.

An archwire designed for edgewise therapy, as shown in FIGS. 18, 19 and 20 of U.S. Pat. No. 4,531,911, has rectangular cross-sectional configuration and is defined by precision oppositely facing parallel planar archwire surfaces that establish force transmitting relation with corresponding parallel archwire slot surfaces 22 and 24 of a uni-twin edgewise orthodontic bracket. As mentioned above, the spring-like archwire has significant elastic memory and is twisted by an orthodontist for insertion into the angulated archwire slots of the various orthodontic brackets of the teeth of a patient. As the spring-like archwire tends to return to its initial, non-twisted configuration, it imparts torque force to the orthodontic bracket and thus to the teeth to which the individual brackets are bonded or otherwise mounted. With desired archwire slot orientation and also through the use of tiewings and other auxiliaries, the teeth of a patient undergoing orthodontic treatment will be moved over a long period of time within the bone structure of the alveolar arch structure of the patient as bone structure is adsorbed and resorbed to permit force responsive tooth movement to final positions that are defined largely by the curved configuration of the intermediate section of the edgewise archwire.

The prior art uni-twin orthodontic bracket 10 of FIGS. 7 and 8 defines mesial and distal tiewing sections 30 and 32, respectively, the mesial tiewing section defining a pair of opposed mesial tiewings 34 and 36 and the distal tiewing section defining a pair of opposed distal tiewings 38 and 40. Mesial and distal archwire relief areas 42 and 44 are defined, respectively, by the mesial and distal ends of the bracket body structure and are each located substantially centrally between the respective mesial and distal pairs of opposed tiewings. As indicated by the prior art views of FIGS. 7 and 8, the archwire relief areas are typically formed by milling operations so that each archwire relief area has diverging relief side edges 46 and 48 and semi-circular end edges 50. The bottom surfaces 52 of the archwire relief areas 42 and 44 are cut so as of be of greater buccal/lingual depth as compared with the depth of the precision archwire slot 26, to thereby provide for archwire relief in depth as well as occlusal/gingival width from the respective mesial and distal ends of the archwire slot. This feature provides the uni-twin edgewise orthodontic bracket with the effective interbracket width that would ordinarily exist if single width orthodontic brackets were utilized.

Milling of the archwire relief areas 42 and 44 is typically done with a rotary milling cutter or burr, with a cutter having a cutter dimension of 0.040 mm being typically used. Thus, the archwire relief areas are much wider than is required for archwire clearance. Moreover, the wide archwire relief areas significantly weaken the bracket structure and can cause splitting of the bracket, especially if the bracket is composed of one of the polymer materials that are currently in use for edgewise orthodontic brackets. It is desirable therefore, to minimize the width of the archwire relief areas and thus promote the structural integrity of the orthodontic brackets, regardless of the material of which they are composed.

As a milling cutter is used to cut the archwire relief areas of conventional edgewise uni-twin orthodontic brackets, and the angulated precision archwire slot is encountered, the cutter will create a curved fulcrum edge with the inclined bottom surface of the archwire slot, making the archwire relief areas somewhat deeper as compared with the depth of the archwire slot. These fulcrum edges will be contacted by the archwire in essentially point-to-point or line contact and will interfere with the rotational and over-rotational control of the bracket. It is desirable to ensure that an improved edgewise uni-twin orthodontic bracket does not define fulcrum edges at the ends of the archwire slot that might interfere with the rotational and over-rotational control of the bracket. Also, the machining process that is utilized during the manufacture of conventional edgewise uni-twin orthodontic brackets typically leaves rather sharp and burred corners and edges that must be removed during a bracket finishing process to eliminate the potential for cutting the labial and facial tissue of the patient during the period of orthodontic treatment. Typically, the machined brackets are tumbled for a significant period of time in a tumbling medium to remove the sharp and burred corners and edges, thus adding significantly to the time and cost of the manufacturing process. It is also desirable to provide for manufacture of the improved brackets in a manner that will yield rounded or radiused finishing of the corners and edges of the bracket structure without requiring a tumbling procedure.

Referring now to FIGS. 1 and 2 of the drawings, an improved uni-twin type edgewise orthodontic bracket, constructed according to the principles of the present invention, is illustrated generally at 60. The orthodontic bracket 60 includes a base or bracket body 62, which is adapted to be secured in immovable relation with a single tooth of a patient undergoing orthodontic therapy. The base 12 may be secured to a metal band encircling the tooth, such as by spot welding if desired, or in the alternative, the base structure may be prepared for direct bonding to the enamel surface of a patient's tooth. The base portion of the orthodontic bracket is preferably formed of metal such as stainless steel or a precious metal, but if desired, the base and the other components of the orthodontic bracket structure may be composed of any suitable metal or nonmetal material capable of being utilized for accomplishment of edgewise orthodontic therapy. The base structure 62 can be adapted to be secured to bands or can be bonded or otherwise attached directly to the teeth of the patient in such manner that the archwire is oriented in as close proximity with the labial and buccal surfaces of the patient's teeth as is practical, thus providing for efficiency of force transmission of the edgewise archwire to the teeth.

As is evident from FIGS. 1 and 2-6 of the drawings, the base structure 62 defines an intermediate bracket section 64 and mesial and distal bracket or tiewing sections 66 and 68. Within the intermediate bracket section 64 is defined a precision archwire slot 70 that is defined by spaced parallel planar surfaces 72 and 74 and a planar bottom surface oriented in perpendicular relation with the spaced parallel planar surfaces. The precision dimensions of the edgewise archwire slot 70 permit an archwire, having a corresponding rectangular cross-sectional configuration and being of precision dimension, to be received in efficient force transmitting relation with respect to the spaced parallel surfaces of the precision archwire slot, so that torque, tipping and rotation forces established by archwire twisting and orientation are transmitted from the archwire to the surfaces of the precision slot structure of the intermediate bracket section and thence to the tooth to which the bracket is bonded or otherwise affixed.

The bracket body or base structure 62 defines a facial surface 78 which is located intermediate the bracket width and may be of planar or slightly curved configuration as desired. The spaced parallel surfaces 72 and 74 of the archwire slot 70 are oriented in substantially perpendicular relation with the facial surface 78, so that the archwire slot is oriented an angle of 0° torque with respect to the facial surface. The bracket body or base structure 62 also defines a base plane 80, which is illustrated by broken lines in FIG. 1 and which is disposed in generally parallel relation with the facial surface 78 and with the bottom surface 76 of the archwire slot. This arrangement of a normal or 90° relationship of the spaced parallel slot surfaces 72 and 74 with the facial surface 78 and also with the base plane 80 results in 0° torque transmitting relation of the archwire slot with respect to both the facial surface 78 and be base plane 80.

It is typically desirable that the archwire slot be arranged in desired angular relation with the labial surface of a patient's tooth so that in most cases, torque force is applied to the tooth by the archwire. With the archwire slot angulated at a desired torque angle with respect to the labial surface of a tooth, the archwire is twisted by the orthodontic practitioner and is inserted into the archwire slot. Because of its spring-like nature and elastic memory, the twisted archwire will tend to untwist and in doing so will impart a torque force to the parallel archwire slot surfaces of the bracket and to the tooth to which the bracket is fixed. Since the precision archwire slot has a torque angle of 0° with respect to the geometry of the bracket base, assuming torque force is to be applied to a tooth, it is appropriate to position the bracket base with respect to a patient's tooth, such that the precision edgewise archwire slot is oriented at a desired angle of torque with respect to the surface of the patient's tooth to which the orthodontic bracket is fixed. According to the present invention, a mounting base surface 82 is defined by the bracket body or base 62 and is angularly oriented relative to the base plane 80 and the facial surface 78, thus causing the archwire slot 70 to be angularly oriented with respect mounting base surface and thus with respect to the surface of the tooth to which the mounting base surface if affixed. As shown in FIG. 1, the mounting base surface 82, typically being a planar or slightly curved surface, is oriented at an angle of 12° with respect to the base plane 80, thus orienting the precision edgewise archwire slot at an angle of 12° with respect to the patient's tooth surface to which the mounting base surface 82 is affixed. Thus, the bracket is designed for a torque of 12°. It should be borne in mind that the bracket can be designed for any suitable angle of torque or no torque, simply by preparing the bracket with a mounting base surface of desired angular relationship with respect to the base plane, facial surface and archwire slot.

The mesial bracket section 66 defines a pair of opposed mesial tiewings 84 and 86 and the distal bracket section defines a pair of opposed distal tiewings 88 and 90. Through the use of ligation control with wire ligatures or elastic ligatures, rotation and over-rotation forces may be applied to the bracket structure and thus to the tooth from the edgewise archwire.

Mesial and distal archwire relief areas 92 and 94 are formed in the mesial and distal sections 66 and 68 of the bracket body or base 62 and are each defined by relief side surfaces 96 and 98 and by relief area bottom surfaces 100. The relief side surfaces are designed to establish an outwardly flared relief for the archwire, while ensuring the structural integrity of the bracket structure. This feature has special importance when polymer material are utilized to form the bracket structure. The relief side surfaces include substantially parallel side surface sections and non-arcuate transition sections extending from said parallel side surface sections to said parallel side surfaces of the archwire slot. The non-arcuate sections may be relatively straight and disposed in outwardly diverging relation or they may be curved transition surfaces, including side surfaces sections of compound curvature. The archwire relief areas are of minimal width, 0.30 mm for example, to ensure maximum structural integrity of the bracket structure, especially if polymer materials are used for its manufacture, without interfering with the clearance of the archwire from end positions of the bracket. It has been determined that positioning of the edgewise archwire more closely to the surface of the tooth to which the bracket is to be mounted, as compared with conventional uni-twin orthodontic brackets, such as shown in FIGS. 7 and 8, enhances the efficiency of orthodontic treatment. As shown particularly in FIG. 1 and as is evident from FIGS. 2-6 as well, the bottom surface 76 of the archwire slot 70 is located at a depth that does not exceed the depth of the mesial and distal archwire relief areas 92 and 94. As shown in FIGS. 1-3. the bottom surface 76 of the precision archwire shot is substantially coplanar with the bottom surfaces 100 of the archwire relief areas 92 and 94. This feature of the uni-twin edgewise orthodontic bracket of the present invention permits the archwire to be located more closely with the surface of the tooth to which the bracket is affixed, as compared with conventional uni-twin orthodontic brackets, and thus provides greater efficiency of the force interaction between the archwire and the tooth and thus resulting greater efficiency of tooth movement within the alveolar arch of the patient. By locating the archwire quite close to the tooth of the patient adjustment of force application of the bracket to the tooth is active for longer periods of time, as compared with orthodontic treatment with conventional uni-twin brackets, and the need for adjustments by an orthodontics practitioner is less frequent in comparison, to the mutual benefit of the patient and orthodontist.

It has been determined through the development of the improved uni-twin edgewise orthodontic bracket of the present invention, that manufacture of uni-twin orthodontic brackets using an injection molding process, with powdered metal, such as stainless steel being injection molded and sintered, results in an appliance structure having rounded or radiused corners and edges, thus eliminating the necessity for an additional tumbling process during manufacture. Thus, the improved uni-twin edgewise orthodontic bracket are essentially of finished form as they emerge from the injection and sintering molds.

Especially if the improved uni-twin edgewise orthodontic brackets of the present invention are manufactured from a material other than metal, a polymer material for example, the narrow relief areas at the respective mesial and distal ends of the archwire slot and orientation of the archwire slot in perpendicular relation with the facial surface of the bracket enhances the structural integrity of the bracket structure. This feature prevents the bracket from splitting during application or use as an edgewise archwire applies tipping and torquing forces during therapy. Further, the ligation forces for rotation and over-rotation during therapy will not tend to split the bracket of the present invention.

Referring now to the longitudinal sectional view of FIG. 4, which represents an alternative embodiment of the present invention, the bottom surface 76 of the precision archwire slot is of greater depth as compared with the depth of the bottom of the mesial and distal relief area surfaces 100. According to this embodiment, the bottom surfaces 100 of the mesial and distal relief areas are shown to be substantially co-planar with one another and generally parallel with the bottom surface 76 of the precision edgewise archwire slot 70. For rotation and over-rotation control of teeth through use of the improved uni-twin edgewise orthodontic bracket of the present invention, it is important that the depth of the archwire relief areas be the same or less than the depth of the archwire slot. This feature provides fulcrums at the mesial and distal ends of the bracket structure which are used, responsive to litigation forces, for application of rotational forces to the teeth of the patient.

According to the alternative embodiment of FIG. 5, it is not necessary that the bottom surfaces of the mesial and distal relief areas be defined by surfaces that are parallel with the bottom surface of the precision edgewise archwire slot. As shown, the bottom surfaces 100 of the mesial and distal relief areas are inclined, with the minimum depth of the relief areas being less than the depth of the precision archwire slot and with the maximum depth of the relief areas being substantially equal to the depth of the precision edgewise archwire slot. It should be borne in mind that the mesial and distal relief areas may be defined by surfaces that are other than planar, assuming that the depth of the relief areas is equal to or less than the depth of the precision archwire slot.

As shown in the alternative embodiment of FIG. 6, the bottom surfaces 100 of the mesial and distal relief areas are oppositely sloped as compared to the embodiment of FIG. 5, and the maximum depth of the mesial and distal relief areas is established at the intersection of the planar bottom surfaces 100 with the respective mesial and distal ends of the bottom surface 76 of the archwire slot 70. Here again, the maximum depth of the mesial and distal relief areas is not greater than the depth of the precision archwire slot.

In view of the foregoing it is evident that the present invention is one well adapted to attain all of the objects and features hereinabove set forth, together with other objects and features which are inherent in the apparatus disclosed herein.

As will be readily apparent to those skilled in the art, the present invention may easily be produced in other specific forms without departing from its spirit or essential characteristics. The present embodiment is, therefore, to be considered as merely illustrative and not restrictive, the scope of the invention being indicated by the claims rather than the foregoing description, and all changes which come within the meaning and range of equivalence of the claims are therefore intended to be embraced therein.

I claim:

1. A uni-twin orthodontic bracket, comprising:
a bracket base defining a central bracket section and mesial and distal tie-wing sections;
said central bracket section defining a precision edgewise slot having mesial and distal ends and having parallel slot side surfaces and a slot bottom surface and adapted to receive an edgewise archwire in force transmitting relation with said parallel slot side surfaces;
a mounting surface being defined by said bracket base and being oriented at a desired torque angle with respect to said parallel slot side surfaces, said mounting surface adapted to be fixed in relation to the facial surface of a patient's tooth and, when so fixed, positioning said parallel slot side surfaces at a desired torque angle enabling an edgewise archwire to apply desired torque force through said bracket base to the patient's tooth;
pairs of opposed mesial and distal tie-wings projecting from said mesial and distal bracket sections and adapting said uni-twin orthodontic bracket for ligation of an edgewise archwire within said precision edgewise archwire slot; and
said mesial and distal bracket sections each defining archwire relief slots extending from respective mesial and distal ends of said precision edgewise archwire slot and having occlusal and gingival relief surfaces having clearance with an edgewise archwire located within said precision edgewise archwire slot.

2. The uni-twin orthodontic bracket of claim 1, comprising:
said bracket base having a facial surface of substantially planar configuration and beng intersected by said precision archwire slot;
said bracket base having a base plane being oriented in substantially parallel relation with said facial surface and in substantially perpendicular relation with said parallel slot side surfaces; and
said mounting surface being oriented in angular relation with said facial surface and establishing a desired torque force angle.

3. The uni-twin orthodontic bracket of claim 1, comprising:
a facial surface being defined by said bracket base having a least a portion thereof defining a substantially planar region, said facial surface being intersected by said precision archwire slot and said spaced parallel surfaces being disposed in substantially perpendicular relation with said substantially planar region of said facial surface.

4. The uni-twin orthodontic bracket of claim 1, comprising:
a facial surface being defined by said bracket base having a least a portion thereof defining a substantially planar region, said facial surface being intersected by said precision archwire slot and said spaced parallel surfaces being disposed in substantially perpendicular relation with said substantially planar region of said facial surface;
said bracket base having a base plane being oriented in substantially parallel relation with said facial surface and being in substantially perpendicular relation with said spaced parallel surfaces; and
said mounting surface having angular orientation with respect to said base plane and said facial surface, the angle thereof being a selected torque angle orienting said parallel surfaces of said precision archwire slot at the selected torque angle when said mounting base surface is disposed in fixed relation with a tooth of a patient.

5. The uni-twin orthodontic bracket of claim 1, comprising:
said archwire relief areas having a depth substantially equal to the depth of said precision archwire slot.

6. The uni-twin orthodontic bracket of claim 1, comprising:
said archwire relief areas having a depth less than the depth of said precision archwire slot.

7. The uni-twin orthodontic bracket of claim 1, comprising:
said archwire relief areas having relief bottom surfaces being disposed in parallel relation with said slot bottom surface; and
said archwire relief areas having a depth substantially equal to the depth of said precision archwire slot.

8. The uni-twin orthodontic bracket of claim 1, comprising:
said archwire relief areas having relief bottom surfaces being disposed in angular relation with said slot bottom surface; and
said archwire relief areas having a depth not greater than the depth of said precision archwire slot.

9. The uni-twin orthodontic bracket of claim 1, comprising:
said archwire relief areas having gingival and occlusal relief surfaces; and
said archwire relief areas having a depth substantially equal to the depth of said precision archwire slot.

10. The uni-twin orthodontic bracket of claim 1, comprising:
said bracket body being composed of sintered metal material.

11. The uni-twin orthodontic bracket of claim 1, comprising:
said bracket body being composed of a polymer material.

12. A uni-twin orthodontic bracket, comprising:
a bracket base defining a central bracket section and mesial and distal tie-wing sections;
said bracket base having a facial surface and defining a precision edgewise slot having mesial and distal ends and having parallel slot side surfaces being oriented substantially perpendicular to said parallel slot side surfaces and having a slot bottom surface, said archwire slot adapted to receive an edgewise archwire in force transmitting relation with said parallel slot side surfaces and having a substantially 0° torque relationship with said facial surface;
a mounting surface being defined by said bracket base and being oriented at a desired torque angle with respect to said parallel slot side surfaces, said mounting surface adapted to be fixed in relation with a patient's tooth and, when so fixed, positioning said parallel slot side surfaces at a desired torque angle enabling an edgewise archwire to apply desired torque force through said bracket base to the patient's tooth;
pairs of opposed mesial and distal tie-wings projecting from said mesial and distal bracket sections and adapting said uni-twin orthodontic bracket for ligation of an edgewise archwire within said precision edgewise archwire slot; and
said mesial and distal bracket sections each defining archwire relief areas extending from respective mesial and distal ends of said precision edgewise archwire slot and having occlusal and gingival relief surfaces having clearance with an edgewise archwire located within said precision edgewise archwire slot, said archwire relief areas having a depth not exceeding the depth of said precision edgewise archwire slot.

13. The uni-twin orthodontic bracket of claim 12, comprising:
said archwire relief areas having a maximum width of about 0.030 mm

14. The uni-twin orthodontic bracket of claim 12, comprising:
said facial surface being defined by said bracket base having a least a portion thereof defining a substantially planar region, said facial surface being intersected by said precision archwire slot and said spaced parallel surfaces being disposed in substantially perpendicular relation with said substantially planar region of said facial surface;
said bracket base having an imaginary base plane being oriented in substantially parallel relation with said facial surface and being in substantially perpendicular relation with said spaced parallel surfaces; and
said mounting surface having angular orientation with respect to said imaginary base plane and said facial surface, the angle thereof being a selected torque angle orienting said parallel surfaces of said precision edgewise archwire slot at the selected torque angle when said mounting base surface is disposed in fixed relation with a tooth of a patient.

15. The uni-twin orthodontic bracket of claim 12, comprising:
said archwire relief areas having a depth substantially equal to the depth of said precision archwire slot.

16. The uni-twin orthodontic bracket of claim 12, comprising:
said archwire relief areas having a depth less than the depth of said precision archwire slot.

17. The uni-twin orthodontic bracket of claim 12, comprising:
said archwire relief areas having relief bottom surfaces being disposed in parallel relation with said slot bottom surface; and
said archwire relief areas having a depth substantially equal to the depth of said precision archwire slot.

18. A uni-twin orthodontic bracket, comprising:
a bracket base composed of sintered metal and defining a central bracket section and mesial and distal tie-wing sections and defining a facial surface;
said central bracket section defining a precision edgewise slot having mesial and distal archwire slot ends and having parallel slot side surfaces oriented substantially perpendicular to said facial surface and having a slot bottom surface, said archwire slot adapted to receive an edgewise archwire in force transmitting relation with said parallel slot side surfaces and having a substantially 0° torque relationship with said facial surface;
a mounting surface being defined by said bracket base and being oriented at a desired torque angle with respect to said parallel slot side surfaces, said mounting surface adapted to be fixed to a patient's tooth and, when so fixed, positioning said parallel slot side surfaces at a desired torque angle enabling an edgewise archwire to apply desired torque force through said bracket base to the patient's tooth;
pairs of opposed mesial and distal tie-wings projecting from said mesial and distal bracket sections and adapting said uni-twin orthodontic bracket for ligation of an edgewise archwire within said precision edgewise archwire slot; and
said mesial and distal bracket sections each defining narrow archwire relief areas having a maximum width of about 0.030 mm and extending from respective mesial and distal ends of said precision edgewise archwire slot and having occlusal and gingival relief surfaces and a relief bottom surface, said occlusal and gingival relief surfaces having clearance with an edgewise archwire located within said precision edgewise archwire slot, said archwire relief areas having a depth not exceeding the depth of said precision edgewise archwire slot, said relief bottom surface establishing a rotational fulcrum enabling application of rotational forces to said orthodontic bracket through ligation for rotational movement of the teeth of a patient.
